(19) United States
(12) Patent Application Publication
(10) Pub. No.: US 2010/0023686 A1
(43) Pub. Date: Jan. 28, 2010

(54) METHOD FOR IMPROVING RAID 1 READING EFFICIENCY

(76) Inventors: Chih-Wei CHEN, Taipei City (TW); Hsiao-Fen Lu, Taipei City (TW)

Correspondence Address: BRIAN M. MCINNIS, 12th Floor, Ruttonjee House, 11 Duddell Street, Hong Kong, HK

(21) Appl. No.: 12/237,965

(22) Filed: Sep. 25, 2008

(30) Foreign Application Priority Data
Jul. 22, 2008 (TW) 97127844

(51) Int. Cl. G06F 12/02

(52) U.S. Cl. 711/114; 711/E12.002

(57) ABSTRACT

A method for improving redundant array of inexpensive disks 1 (RAID 1 array) reading efficiency, which includes providing a disk head address of each disk in a RAID 1 array; receiving a read command and providing a reading file address of the read command; choosing a first preferred disk from the disks in the RAID 1 array, which has a disk head address closest to the reading file address among disks of the RAID 1 array; and sending the read command to the first preferred disk.

### RELATED APPLICATIONS

This application claims priority to Taiwan Application Serial Number 97127844, filed Jul. 22, 2008, which is herein incorporated by reference.

### BACKGROUND

1. Field of Invention

The present invention relates to method for improving disk reading efficiency. More particularly, the present invention relates to a method for improving RAID 1 reading efficiency.

2. Description of Related Art

RAID (Redundant Array of Inexpensive Disks) combines multiple small, inexpensive disks into a single storage array. RAID arrays perform at high capacity, high speed, and have high availability. A RAID controller aggregates the disks to know where or how the data is being placed on the storage media. The RAID system can provide data backup and data fault tolerant functions.

Generally speaking, multiple RAID levels specify how the data is distributed across the storage array. RAID levels include N-RAID (non-RAID or disk spanning), RAID 0 (disk striping), RAID 1 (disk mirroring), RAID 2, RAID 3, RAID 4, RAID 5, and RAID 6 and also various combinations among them. In a RAID 0 configuration, data is striped onto multiple disks. In a RAID 1 configuration, a minimum of two disks is required, and the data on one disk is mirrored onto the second disk. The data can be backed-up by mirroring storage in the disks in the RAID 1 configuration. In a RAID 2 configuration, bit-level striping with Hamming code ECC is used to distribute data across the RAID array.

In the RAID 1 configuration, data from one disk is mirrored on the second disk. The file addresses on both disks in the RAID 1 array are the same. The conventional method for reading the data of the RAID 1 is distributing the read commands to the disks in sequence. However, the disk arm and the motor are mechanism, the moving time of the disk head is much longer than the reading time of the disk head. The conventional method for reading the data in RAID 1 cannot reduce the movement time of the disk head.

### SUMMARY

The present invention is directed to a method for reading data stored in a RAID 1 array that minimizes the moving time of the disk head and improves the reading efficiency of RAID 1

The embodiment of the invention provides a method for improving redundant array of inexpensive disks 1 (RAID 1) reading efficiency, which includes providing a disk head address of each disk in the RAID 1 array; receiving a read command and providing a reading file address of the read command; choosing a first preferred disk from the disks in the RAID 1 array, wherein the first preferred disk has a disk head address closest to the reading file address among disks of the RAID 1 array; and sending the read command to the first preferred disk.

Another embodiment of the invention provides a method for improving redundant array of inexpensive disks 1 (RAID 1) array reading efficiency, which includes recording a disk head address of each disk in a RAID 1 array to a disk head address table; receiving a read command and providing a reading file address of the read command; comparing the reading file address with the disk head addresses in the disk head address table; choosing a first preferred disk from the disks in the RAID 1, wherein the first preferred disk has a disk head address closest to the reading file address among disks in the RAID 1 array; comparing an unread command number of the first preferred disk with an upper processing limit; and sending the read command to the first preferred disk when the unread command number is smaller than the upper processing limit.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart diagram of an embodiment of the method for improving RAID 1 reading efficiency of the invention; and

FIG. 2 is a flow chart diagram of another embodiment of the method for improving RAID1 reading efficiency of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The RAID 1 array is mainly used to backup data. The data is mirrored onto the disks of the RAID 1 array. The data file addresses on each disk in the RAID 1 array are therefore the same. The read commands are sent to different disks in the RAID 1 array, and the disk head address of the disks in the RAID 1 array are different after the reading processes.

However, the disk arm and the motor are mechanisms, the moving time of the disk head is much longer than the reading time of the disk head when the disk head reads the data. The present invention provides a method for improving RAID 1 array reading efficiency by arranging the path of the disks in RAID 1 array to shorten the moving time of the disk head.

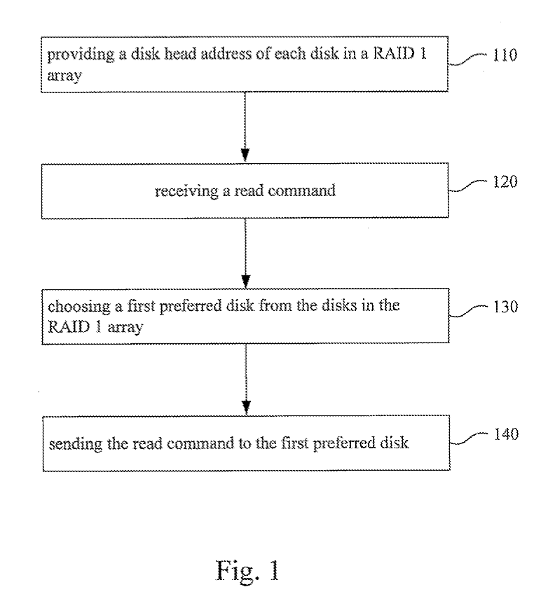

Refer to FIG. 1. FIG. 1 illustrates a flow chart diagram of an embodiment of the method for improving RAID 1 array reading efficiency of the invention. Step 110 provides a disk head address of each disk in the RAID 1 array. In step 120, the RAID 1 array receives a read command and proving a reading file address requested by the read command. In step 130, a first preferred disk is chosen from the disks of the RAID 1 array, wherein the first preferred disk has the disk head address closest to the reading file address among the disks in the RAID 1 array. In step 140 the read command is sent to the first preferred disk for reading.

The disk head address of the first preferred disk is the closest one to the reading file address among the disks in the RAID 1, thus the time to move the disk arm of the first preferred disk to the reading file address is shorter than other disks in RAID 1. The present invention can choose the first preferred disk among the disks of the RAID 1 array, which has the shortest path of the disk arm, thus the moving time of the disk arm could be minimized to improve the reading efficiency of the RAID 1.

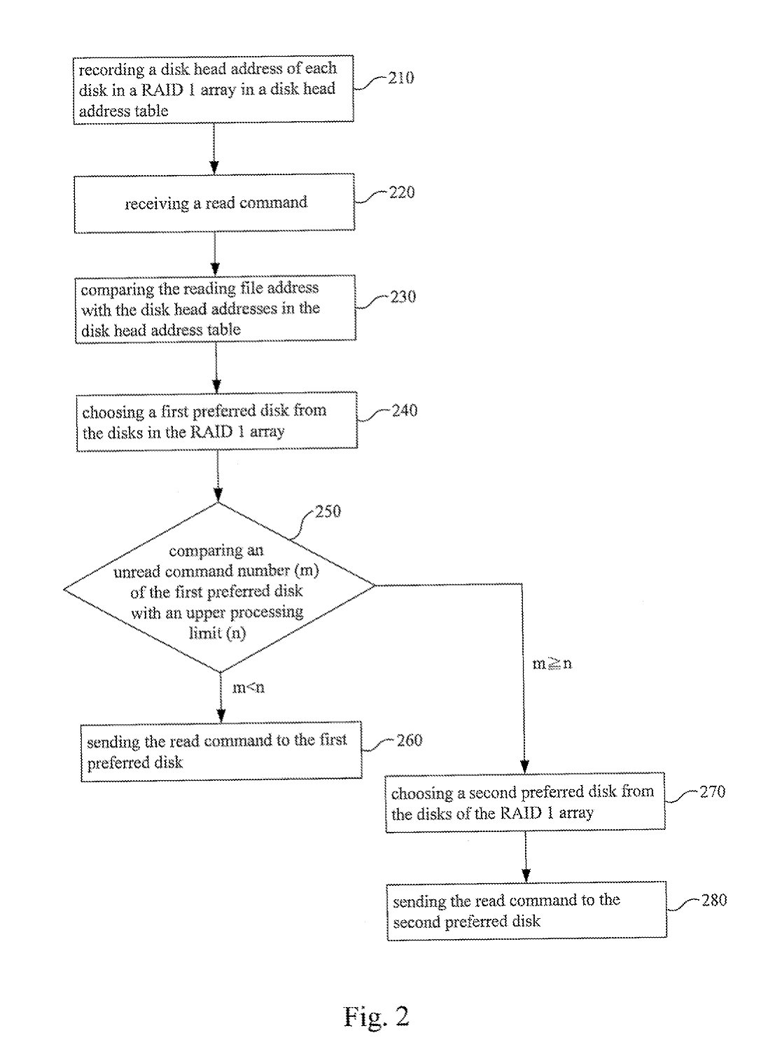

Refer to FIG. 2. FIG. 2 illustrates a flow chart diagram of another embodiment of the method for improving RAID 1 reading efficiency of the invention. The present embodiment can prevent too many read commands from being sent to the same disk and delay the reading efficiency when the reading file addresses of the mass read commands are in the neighbor block.

In step 210, the disk head address of each disk in the RAID 1 array is recorded in a disk head address table. In step 210, the disk head address is updated in the disk head address table after writing or reading from the disk. In step 220, the RAID 1 array receives a read command and provides the reading file address requested by the read command. In step 230, the reading file address is compared with the disk head addresses in the disk head address table. In step 240, a first preferred disk is chosen from the disks in the RAID 1 array, wherein the first preferred disk has the disk head address closest to the reading file address among disks of the RAID 1. Namely, the path of the disk head of the first preferred disk is the shortest one among the disks of the RAID 1 array.

In step 250, an unread command number (m) of the first preferred disk is compared with an upper processing limit (n) to determine whether the first preferred disk is overloaded with too many read commands or not. The read command is sent to the first preferred disk in step 260 when the unread command number of the first preferred disk is smaller than the upper processing limit

However, if the unread command number of the first disk is not smaller than the upper processing limit, the read command is no longer sent to the first preferred disk to prevent too many read commands from being send to the first preferred disk and delaying the reading efficiency of the first preferred disk. Then, in step 270, a second preferred disk is chosen from the disks of the RAID 1 array when the unread command number of the first preferred disk is not smaller than the upper processing limit, wherein the second preferred disk has the disk address closest to the reading file address among the disks of RAID 1 array except for the first preferred disk. The first preferred disk is excludes from the choosing list when the RAID 1 array chooses the second preferred disk. The path of the disk head of the second preferred disk is the shortest one among the disks except for the first preferred disk in the RAID 1 array. Then, in step 280, the read command is sent to the second preferred disk.

The invention can choose the first preferred disk that has the shortest path to move the disk head, and the moving time of the disk head can be minimized. The reading efficiency of the RAID 1 array can be highly improved by sending the read command to the first preferred disk, which is closest to the reading file address. The read commands with neighbor address can be aggregated to the same disk, and the read commands can be executed in a short time. The invention also sets the upper processing limit of each disk in the RAID 1 array to prevent that too many read commands send to the same disk and delay the reading efficiency of the disk.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for improving RAID 1 array reading efficiency comprising:
providing a disk head address of each disk in a RAID 1 array;
receiving a read command and providing a reading file address requested by the read command;
choosing a first preferred disk from the disks in the RAID 1 array, wherein the first preferred disk has a disk head address closest to the reading file address among disks of the RAID 1 array; and
sending the read command to the first preferred disk.

2. A method for improving RAID 1 array reading efficiency comprising:
recording a disk head address of each disk in a RAID 1 array in a disk head address table;
receiving a read command and providing a reading file address requested by the read command;
comparing the reading file address with the disk head addresses in the disk head address table;
choosing a first preferred disk from the disks in the RAID 1 array, wherein the first preferred disk has a disk head address closest to the reading file address among disks of the RAID 1 array;
comparing an unread command number of the first preferred disk with an upper processing limit; and
sending the read command to the first preferred disk when the unread command number is smaller than the upper processing limit.

3. The method for improving RAID 1 array reading efficiency of claim 2, wherein the read command is not sent to the first preferred disk when the unread command number is not smaller than the upper processing limit.

4. The method for improving RAID 1 array reading efficiency of claim 3, further comprising choosing a second preferred disk from the disks of the RAID 1 array and sending the read command to the second preferred disk, wherein the second preferred disk has the disk address closest to the reading file address among the disks of RAID 1 array except for the first preferred disk.

5. The method for improving RAID 1 array reading efficiency of claim 2, further comprising updating the disk head address of the first preferred disk in the disk head address table.
